(19) United States
(12) Patent Application Publication
(10) Pub. No.: US 2007/0117665 A1
(43) Pub. Date: May 24, 2007

(54) Automatic transmission

(75) Inventor: Akira Yamazaki, Shizuoka (JP)

Correspondence Address: FOLEY AND LARDNER LLP;SUITE 500, 3000 K STREET NW, WASHINGTON, DC, 20007, US

(73) Assignee: JATCO Ltd

(21) Appl. No.: 11/594,070

(22) Filed: Nov. 8, 2006

(30) Foreign Application Priority Data
Nov. 22, 2005 (JP) 2005-336661

(51) Int. Cl. F16H 61/00

(52) U.S. Cl. 474/28

(57) ABSTRACT

An automatic transmission including a power transmission mechanism, an oil pump and a hydraulic control valve within an oil pan. Input shaft, an output shaft, a countershaft and a differential shaft of the power transmission mechanism are disposed parallel to a width direction of the vehicle and perpendicular to in a fore-and-aft direction of a vehicle. The input shaft is disposed forward of the output shaft, the countershaft and the differential shaft in the fore-and-aft direction of the vehicle. The oil pan and the hydraulic control valve are disposed below the input shaft in a height direction of the vehicle. The oil pump is disposed immediately above the hydraulic control valve and lower than an axis of the input shaft in the height direction of the vehicle and arranged in a space between a torque converter and the power transmission mechanism within a transmission case.

### BACKGROUND OF THE INVENTION

The present invention relates to an automatic transmission, and more particularly to an arrangement of an oil pump and a hydraulic control valve in an automatic transmission.

Japanese Patent Application First Publication No. 2004-197884 indicates an arrangement of an oil pump and a hydraulic control valve in a belt-drive automatic transmission of a vehicle. FIGS. 4 and 5 show the arrangement as indicated in this related art. As illustrated in FIGS. 4 and 5, belt-drive automatic transmission 50 in which a rotation from a power source is inputted to input shaft 52 via torque converter 51 and then transmitted to primary pulley 53 connected to input shaft 52. The rotation is transmitted from primary pulley 53 to secondary pulley 55 through V-belt 54 at a variably controlled gear ratio and outputted to output shaft 56. The rotation outputted is transmitted to driving wheels through drive gear 57 connected to output shaft 56, driven gear 58 connected to drive gear 57, counter shaft 59 connected to driven gear 58, final drive gear set 60, differential gear 61 and differential shaft 62. As illustrated in FIG. 4, input shaft 52, output shaft 56, counter shaft 59 and differential shaft 62 are arranged such that axes thereof are parallel to width direction Z of the vehicle, and input shaft 52, namely, torque converter 51 and primary pulley 53, are located forward of output shaft 56, counter shaft 59 and differential shaft 62.

Belt-drive automatic transmission 50 further includes oil pump 63 for supplying a hydraulic pressure of a working oil which is required to vary a V-shaped groove between pulley halves of respective primary and secondary pulleys 53 and 55 in order to realize a desired gear ratio. Belt-drive automatic transmission 50 further includes hydraulic control valve 64 for producing a hydraulic pressure corresponding to the desired gear ratio which is to be applied to primary and secondary pulleys 53 and 55. As shown in FIG. 4, oil pump 63 is located below input shaft 52 and forward of the axes of output shaft 56 and differential shaft 62, namely, on the right side of a line extending through the axes of output shaft 56 and differential shaft 62. Hydraulic control valve 64 is disposed at a front end of transmission case 65 in fore-and-aft direction X of the vehicle and forwardly projects from the front end of transmission case 65. Meanwhile, reference symbol Y in FIG. 4 denotes a height direction of the vehicle.

### SUMMARY OF THE INVENTION

However, belt-drive automatic transmission 50 is increased in size in fore-and-aft direction X of the vehicle due to the arrangement of hydraulic control valve 64 at a front end of transmission case 65. Further, oil pump 63 and hydraulic control valve 64 are disposed relatively distant from each other. The arrangement of oil pump 63 and hydraulic control valve 64 causes increase in length of an oil passage which extends from oil pump 63 to hydraulic control valve 64. This leads to increase in flow resistance of the oil passage and also causes difficulty in layout of the oil passage.

An object of the present invention is to provide an automatic transmission which is downsized and simplified in layout of an oil passage extending from an oil pump to a hydraulic control valve and allows reduction in flow resistance of the oil passage.

In one aspect of the present invention, there is provided an automatic transmission coupled with a power source in a vehicle, the automatic transmission comprising:

a transmission case;

a torque converter disposed within the transmission case, the torque converter being adapted to be connected with the power source,

a power transmission mechanism disposed within the transmission case, the power transmission mechanism including an input shaft connected with the torque converter, an output shaft connected with the input shaft, a counter shaft connected with the output shaft and a differential shaft connected with the counter shaft,

an oil pump disposed within the transmission case, the oil pump being adapted to be driven by the power source and supply a working oil to the power transmission mechanism;

a hydraulic control valve which controls a hydraulic pressure corresponding to a gear ratio at which the power transmission mechanism is operated; and

an oil pan which accommodates the hydraulic control valve and stores the working oil,

wherein the input shaft, the output shaft, the countershaft and the differential shaft of the power transmission mechanism are disposed parallel to a width direction of the vehicle and perpendicular to in a fore-and-aft direction of the vehicle, and the input shaft is disposed forward of the output shaft, the countershaft and the differential shaft in the fore-and-aft direction of the vehicle;

the oil pan and the hydraulic control valve accommodated in the oil pan are disposed below the input shaft in a height direction of the vehicle; and

the oil pump is disposed immediately above the hydraulic control valve and lower than an axis of the input shaft in the height direction of the vehicle and arranged in a space between the torque converter and the power transmission mechanism within the transmission case.

### BRIEF DESCRIPTION OF THE DRAWINGS

FIG. 1 is a side view of a continuously variable belt drive transmission of an embodiment of the present invention, when viewed in a width direction of a vehicle.

FIG. 2 is a sectional view of the continuously variable belt drive transmission shown in FIG. 1, taken along line 2-2 of FIG. 1.

FIG. 3 is an enlarged view of the continuously variable belt drive transmission shown in FIG. 1, showing an oil pump and the vicinity of the oil pump.

FIG. 4 is a side view of a continuously variable belt drive transmission of a related art.

FIG. 5 is a sectional view of the continuously variable belt drive transmission shown in FIG. 4, taken along line 5-5 of FIG. 4.

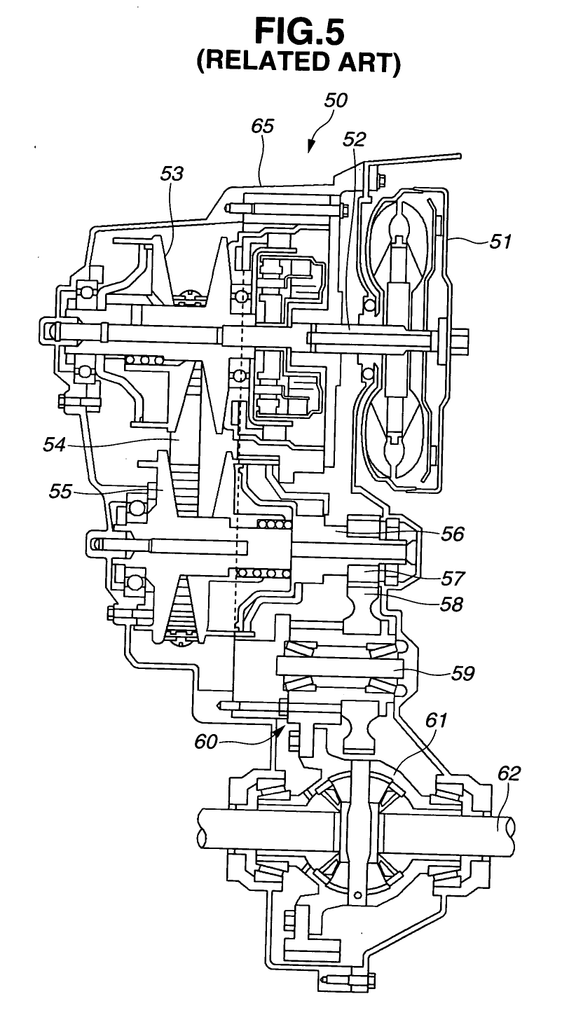

### DETAILED DESCRIPTION OF THE INVENTION

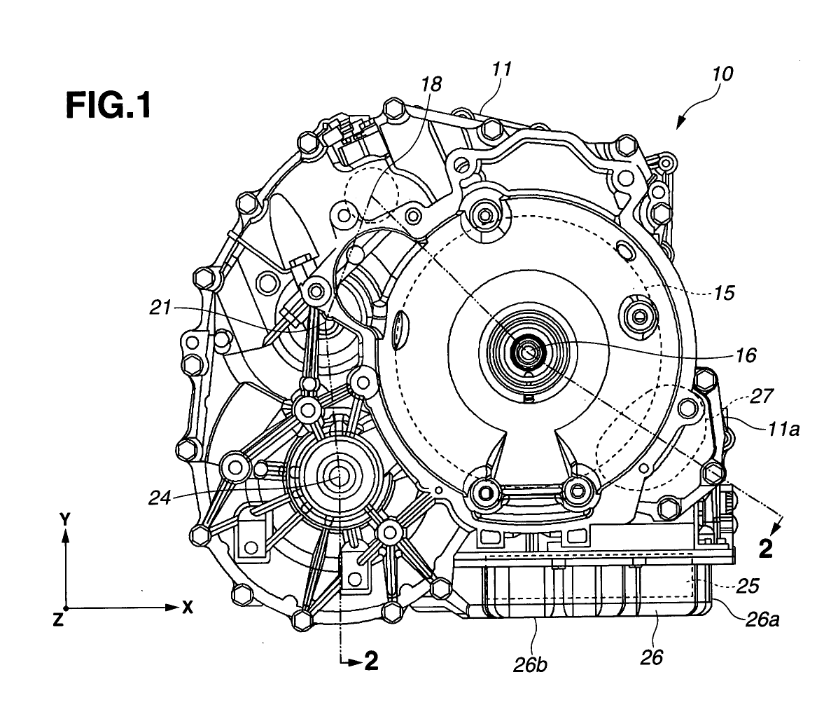

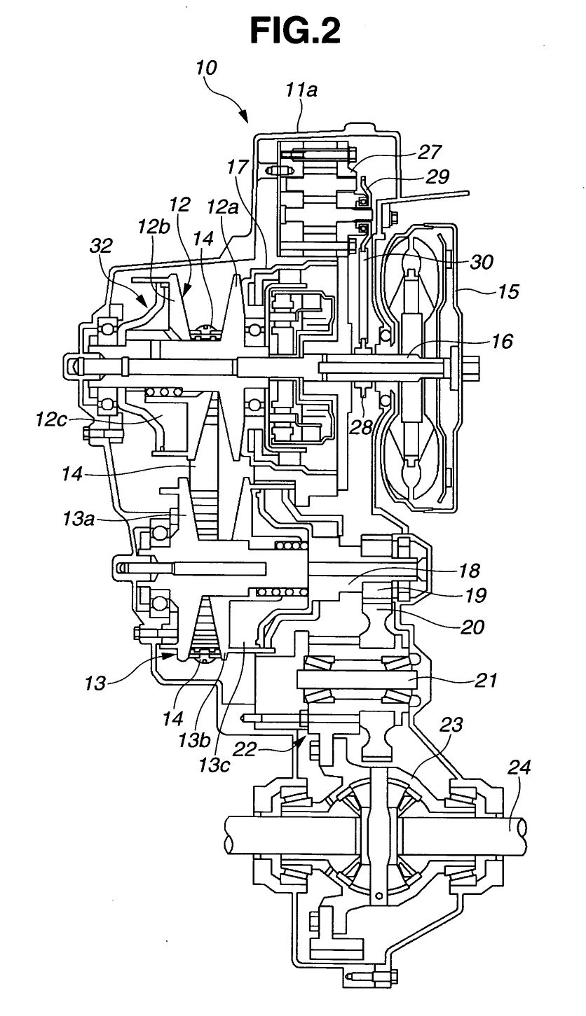

In the followings, an embodiment of the present invention will be described with reference to the accompanying drawings. FIGS. 1-3 illustrate a continuously variable belt drive transmission (hereinafter referred to as a belt drive CVT) for a vehicle, according to the embodiment of the present invention. As illustrated in FIG. 2, belt drive CVT 10 includes transmission case 11, torque converter 15 and power transmission mechanism 32 which are disposed within transmission case 11. Power transmission mechanism 32 includes primary pulley 12, secondary pulley 13 which are connected with each other through V-belt 14, and forward and reverse changeover mechanism 17. Primary pulley 12 and torque converter 15 have a common axis which extends through input shaft 16. Secondary pulley 13 is directly disposed on output shaft 18 parallel to input shaft 16. V-belt 14 is engaged in V-shaped grooves of primary and secondary pulleys 12 and 13 which are aligned with each other in the axial direction of primary and secondary pulleys 12 and 13. Rotation from an engine, not shown, as a power source is inputted to input shaft 16 via torque converter 15. The rotation is transmitted to primary pulley 12 through forward-rearward changeover mechanism 17. The rotation is transmitted from primary pulley 12 to secondary pulley 13 through V-belt 14. The rotation of secondary pulley 13 is transmitted to output shaft 18 connected to secondary pulley 13, drive gear 19 connected to output shaft 18, driven gear 20 connected to drive gear 19, and counter shaft 21 connected to driven gear 20. The rotation of counter shaft 21 is transmitted to driving wheels, not shown, through final drive gear set 22, differential gear unit 23 and differential shaft 24 of differential gear unit 23.

Referring to FIG. 1, there is shown an arrangement of input shaft 16, output shaft 18, counter shaft 21 and differential shaft 24. Input shaft 16, output shaft 18, counter shaft 21 and differential shaft 24 are arranged such that axes thereof are parallel to width direction Z of the vehicle and perpendicular to fore-and-aft direction X of the vehicle. Further, as illustrated in FIG. 2, input shaft 16 is arranged forward of output shaft 18, counter shaft 21 and differential shaft 24. That is, torque converter 15 and primary pulley 12 are located forward of output shaft 18, counter shaft 21 and differential shaft 24. The axes of output shaft 18, counter shaft 21 and differential shaft 24 are located on substantially the same line which extends in height direction Y of the vehicle as indicated by a broken line in FIG. 1. With this arrangement of output shaft 18, counter shaft 21 and differential shaft 24, belt drive CVT 10 can be reduced in size in fore-and-aft direction X of the vehicle. This serves for reducing a space occupied by belt drive CVT 10 within an engine room of the vehicle.

As illustrated in FIG. 2, primary pulley 12 of power transmission mechanism 32 includes stationary disk 12a which rotates integrally with input shaft 16 and moveable disk 12b which is opposed to stationary disk 12a in an axial direction of input shaft 16. Stationary disk 12a and moveable disk 12b cooperate with each other to define the V-shaped groove therebetween. Movable disk 12b is displaceable in the axial direction of input shaft 16 by thrust which is produced by applying a primary pulley oil pressure to primary pulley chamber 12c of primary pulley 12. Similarly, secondary pulley 13 of power transmission mechanism 32 includes stationary disk 13a which rotates integrally with output shaft 18 and moveable disk 13b which is opposed to stationary disk 13a in an axial direction of output shaft 18. Stationary disk 13a and moveable disk 13b cooperate with each other to define the V-shaped groove therebetween. Movable disk 13b is displaceable in the axial direction of output shaft 18 by thrust which is produced by applying a secondary pulley oil pressure to secondary pulley chamber 13c of secondary pulley 13. V-belt 14 engaged with the V-shaped grooves of respective primary and secondary pulleys 12 and 13 transmits the rotation of input shaft 16 to output shaft 18.

Gear ratio control of power transmission mechanism 32 is conducted by continuously varying the effective contact radius of V-belt 14 at the contact position of each of primary and secondary pulleys 12 and 13 by changing a width of the V-shaped grooves of respective primary and secondary pulleys 12 and 13. A target gear ratio is achieved by the gear ratio control.

As illustrated in FIG. 1, hydraulic control valve 25 which controls a hydraulic pressure corresponding to a gear ratio at which power transmission mechanism 32 is operated. Namely, hydraulic control valve 25 for controlling the primary pulley oil pressure and the secondary pulley oil pressure is disposed within oil pan 26 as indicated by a broken line. Hydraulic-control valve 25 produces the primary pulley oil pressure and the secondary pulley oil pressure on the basis of a command signal from a control unit, not shown. Oil pan 26 is mounted to a lower portion of transmission case 11 and stores the working oil.

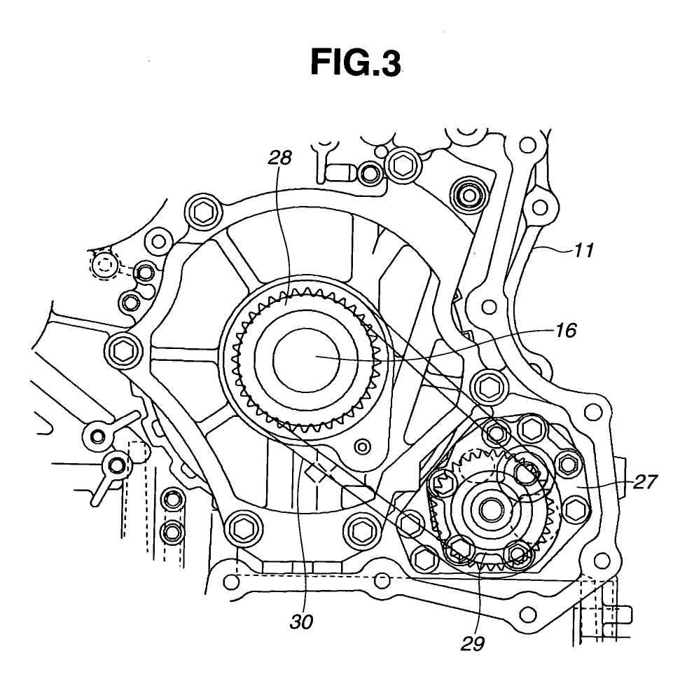

Referring to FIG. 3, there is shown oil pump 27 supplying the working oil which acts as a transmission medium of the primary pulley oil pressure and the secondary pulley oil pressure and lubricates components of belt drive CVT 10. Oil pump 27 is accommodated in an oil pump receptacle portion of transmission case 11 which is forwardly projected in fore-and-aft direction X of the vehicle. Oil pump 27 is driven by the engine via drive sprocket 28, driven sprocket 29 and chain 30 which is would on drive and driven sprockets 28 and 29. Drive sprocket 28 is mounted to torque converter 15. Driven sprocket 29 is directly coupled to oil pump 27. Driven sprocket 29 has a diameter smaller than that of drive sprocket 28. The rotation outputted from the engine is transmitted to oil pump 27 through drive sprocket 28, driven sprocket 29 and chain 30. Oil pump 27 sucks and pressurizes the working oil within oil pan 26 and supplies the pressurized working oil to hydraulic control valve 25. Owing to the smaller size of driven sprocket 29, oil pump 27 is allowed to produce a high oil pressure with the engine rotation. The pressure of the working oil supplied to hydraulic control valve 25 is regulated on the basis of a command signal from the control unit. The working oil regulated is transmitted from hydraulic control valve 25 to primary and secondary pulleys 12 and 13 and clutches and brakes of forward-rearward changeover mechanism 17 for actuation thereof. The working oil regulated is also transmitted to the components of belt drive CVT 10 for lubrication thereof.

Referring back to FIG. 1, hydraulic control valve 25, oil pan 26 which accommodates hydraulic control valve 25, and oil pump 27 are located in a position lower than the axis of input shaft 16 in height direction Y of the vehicle and are arranged close to each other. Oil pan 26 and hydraulic control valve 25 accommodated in oil pan 26 are disposed below input shaft 16 in height direction Y of the vehicle. Oil pump 27 is disposed immediately above oil pan 26 and hydraulic control valve 25 accommodated in oil pan 26.

With this arrangement of hydraulic control valve 25, oil pan 26 and oil pump 27, it is possible to shorten an oil passage via which the working oil is sucked from oil pan 26 by oil pump 27 and an oil passage via which the working oil is supplied from oil pump 27 to hydraulic control valve 25. A flow resistance of pipes which define the oil passages can be reduced, whereby the layout of the oil passages and the construction thereof can be simplified.

Further, with this arrangement of hydraulic control valve 25, oil pan 26 and oil pump 27, hydraulic control valve 25 can be always supplied with a certain amount of the working oil. Even when the engine is temporarily stopped, the working oil hardly flows out from hydraulic control valve 25. When the engine is restarted, a suitable oil pressure for conducting the gear ratio control can be produced and the lubrication of belt drive CVT 10 can be quickly established.

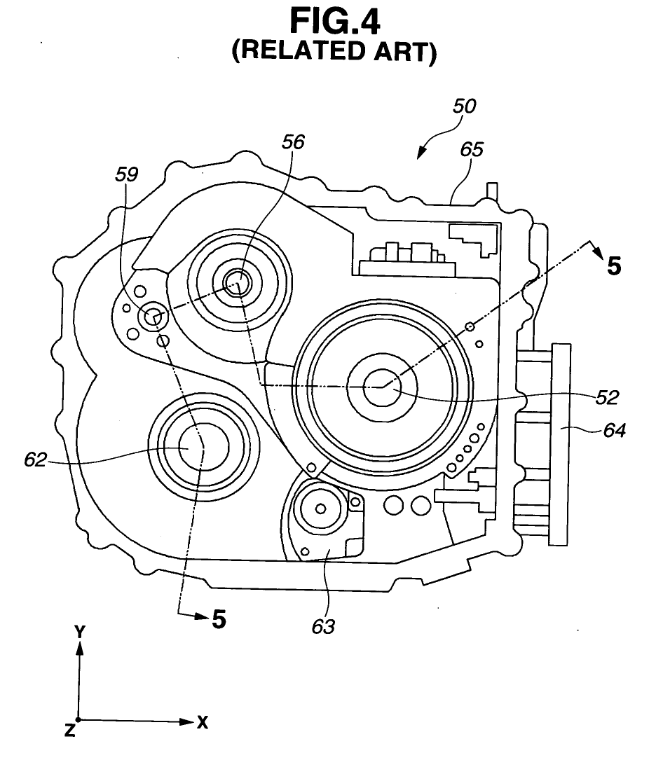

Oil pump 27 is arranged forward of input shaft 16 in fore-and-aft direction X of the vehicle. With this arrangement of oil pump 27, oil pump 27 can be prevented from interfering with other parts upon assembling belt drive CVT 10, specifically, upon mounting oil pump 27 into transmission case 11. The mounting work can be facilitated. Further, as illustrated on the right side of FIG. 1, transmission case 11 includes oil pump enclosing portion 11a which accommodates oil pump 27. Oil pump enclosing portion 11a is located on the front side of transmission case 11 in fore-and-aft direction X of the vehicle and projected forward to form a curve as shown in FIG. 1. An outer-most periphery of oil pump enclosing portion 11a and front end portion 26a of oil pan 26 are located in substantially alignment with in fore-and-aft direction X of the vehicle. That is, oil pump 27, oil pan 26 and hydraulic control valve 25 within oil pan 26 are arranged so as to project forward in fore-and-aft direction X of the vehicle to a lesser extent. With this arrangement of oil pump 27, oil pan 26 and hydraulic control valve 25, the length of belt drive CVT in fore-and-aft direction X of the vehicle can be reduced to thereby realize a downsized belt drive CVT 10, as compared with the belt drive CVT of the related art as shown in FIG. 4.

Oil pump 27 is disposed between torque converter and power transmission mechanism 32 as shown in FIG. 2. Further, oil pump 27 is located in a position adjacent to forward-rearward changeover mechanism 17 which has a circular shape in section and oil pan 26 and hydraulic control valve 25 which have a rectangular shape in section. That is, oil pump 27 is arranged in a dead space between torque converter 15 and power transmission mechanism 32 within transmission case 11. Thus, the dead space in transmission case 11 can be effectively utilized. It is not necessary to provide an additional installation space for accommodating oil pump 27. Oil pump 27 can be arranged in the dead space so as to reduce an amount of the projection in the forward direction of the vehicle to a minimum. This serves for downsizing belt drive CVT 10.

Oil pan 26 is arranged such that bottom 26b thereof is located in either of a position substantially aligned with a lower-most end portion of transmission case 11 in height direction Y of the vehicle and a position higher than the lower-most end portion of transmission case 11 in height direction Y thereof. Namely, bottom 26b of oil pan 26 is located at a height or level with respect to a road surface which is substantially the same as the lower-most end portion of transmission case 11 or higher than the lower-most end portion of transmission case 11. Specifically, the lower-most end portion of transmission case 11 is set at the height with respect to a road surface at which the lower-most end portion can be prevented from contacting with projections on the road surface, for instance, a curb of the road, a car stop, a rockfall and the like. Accordingly, in belt drive CVT 10 of this embodiment, a mount height of oil pan 26, that is, the height of oil pan 26 with respect to the road surface is adjusted to substantially the same as the height of the lower-most end portion of transmission case 11 or to a height higher than the lower-most end portion of transmission case 11. With this construction, the bottom of oil pan 26 can be prevented from being contacted with the projections on the road surface during traveling of the vehicle. This serves for reducing a possibility that oil pan 26 and hydraulic control valve 25 within oil pan 26 suffer from damage which would be caused due to the contact between the bottom thereof and the projections during traveling of the vehicle.

As is understood from the above explanation, the automatic transmission of the present invention can be downsized, especially, in the fore-and-aft direction of the vehicle. This allows to reduce an installation space of the automatic transmission in an engine room of the vehicle. Accordingly, the automatic transmission of the present invention can be applied to a small-sized vehicle, such as a light car, having a narrow engine room which is relatively small in the fore-and-aft direction of the vehicle. Further, owing to the compact layout of the oil pump, the hydraulic control valve and the oil pan, it is possible to reduce flow resistance of the oil passages extending between the oil pump and the oil pan and between the oil pump and the hydraulic control valve and simplify the layout and construction of the oil passages. Further, even when the power source is restarted, an oil pressure for the gear ratio control and the lubrication can be quickly and suitably attained.

Furthermore, the automatic transmission of the present invention is not limited to the belt drive CVT of the above embodiment and can be applied to other types of the automatic transmission such as a gear type (step type) automatic transmission and a toroidal automatic transmission.

This application is based on a prior Japanese Patent Application No. 2005-336661 filed on Nov. 22, 2005. The entire contents of the Japanese Patent Application No. 2005-336661 is hereby incorporated by reference.

Although the invention has been described above by reference to the embodiment of the invention, the invention is not limited to the embodiment described above. Modifications and variations of the embodiment described above will occur to those skilled in the art in light of the above teachings. The scope of the invention is defined with reference to the following claims.

What is claimed is:

1. An automatic transmission coupled with a power source in a vehicle, the automatic transmission comprising:
a transmission case;
a torque converter disposed within the transmission case, the torque converter being adapted to be connected with the power source,
a power transmission mechanism disposed within the transmission case, the power transmission mechanism including an input shaft connected with the torque converter, an output shaft connected with the input shaft, a counter shaft connected with the output shaft and a differential shaft connected with the counter shaft,
an oil pump disposed within the transmission case, the oil pump being adapted to be driven by the power source and supply a working oil to the power transmission mechanism;
a hydraulic control valve which controls a hydraulic pressure corresponding to a gear ratio at which the power transmission mechanism is operated; and
an oil pan which accommodates the hydraulic control valve and stores the working oil,
wherein the input shaft, the output shaft, the countershaft and the differential shaft of the power transmission mechanism are disposed parallel to a width direction of the vehicle and perpendicular to in a fore-and-aft direction of the vehicle, and the input shaft is disposed forward of the output shaft, the countershaft and the differential shaft in the fore-and-aft direction of the vehicle;
the oil pan and the hydraulic control valve accommodated in the oil pan are disposed below the input shaft in a height direction of the vehicle; and
the oil pump is disposed immediately above the hydraulic control valve and lower than an axis of the input shaft in the height direction of the vehicle and arranged in a space between the torque converter and the power transmission mechanism within the transmission case.

2. The automatic transmission as claimed in claim 1, wherein axes of the output shaft, the counter shaft and the differential shaft of the power transmission mechanism are located on substantially same line extending in the height direction of the vehicle.

3. The automatic transmission as claimed in claim 1, wherein the oil pump is arranged forward of the input shaft of the power transmission mechanism in the fore-and-aft direction of the vehicle.

4. The automatic transmission as claimed in claim 1, wherein the transmission case comprises an oil pump enclosing portion which accommodates the oil pump, the oil pan comprises a front end portion in the fore-and-aft direction of the vehicle, and an outer-most periphery of the oil pump enclosing portion of the transmission case and the front end portion of the oil pan are located in substantially alignment with each other in the fore-and-aft direction of the vehicle.

5. The automatic transmission as claimed in claim 1, wherein the oil pan comprises a bottom, the transmission case comprises a lower-most end portion, and the oil pan is arranged such that the bottom is disposed in either of a position substantially aligned with the lower-most end portion of the transmission case in the height direction of the vehicle and a position higher than the lower-most end portion of the transmission case in the height direction thereof.

6. The automatic transmission as claimed in claim 1, wherein the automatic transmission is a belt drive continuously variable transmission.
